(19) United States
(12) Patent Application Publication
(10) Pub. No.: US 2026/0070456 A1
(43) Pub. Date: Mar. 12, 2026

(54) VEHICLE-TO-EVERYTHING (V2X) CHARGING COMMUNICATION SYSTEM

(71) Applicant: International Truck Intellectual Property Company, LLC, Lisle, IL (US)

(72) Inventors: Jeffrey Raymond Mohr, Shelby Township, MI (US); Gary J. Gloceri, Waterford, MI (US)

(73) Assignee: International Truck Intellectual Property Company, LLC, Lisle, IL (US)

(21) Appl. No.: 19/283,327

(22) Filed: Jul. 29, 2025

Related U.S. Application Data
(60) Provisional application No. 63/693,448, filed on Sep. 11, 2024.

(51) Int. Cl. B60L 53/66; B60L 53/67; B60L 53/68; B60L 55/00; H04L 12/40; H04W 4/40

(52) U.S. Cl. CPC B60L 53/66; B60L 53/67; B60L 53/68; B60L 55/00; H04L 12/40; B60L 2200/18; H04L 2012/40215; H04L 2012/40273; H04W 4/40

(57) ABSTRACT

A V2X charging communication system is disclosed. The V2X charging communication system may include a vehicle having a rechargeable battery coupled to the vehicle and a vehicle RF transceiver. The V2X charging communication system may include a first cloud interface in communication with a charging station, where the charging station is configured to charge the rechargeable battery of the vehicle and/or receive charge from the rechargeable battery of the vehicle; and a second cloud interface in communication with the vehicle RF transceiver, where the first cloud interface and the second cloud interface are configured to transmit charge/recharge instructions from one or more charge management systems remote from the vehicle.

### REFERENCE TO RELATED APPLICATIONS

This patent application claims priority from U.S. provisional patent application Ser. No. 63/693,448 filed on Sep. 11, 2024. That provisional patent application is incorporated herein in its entirety by this reference.

### FIELD OF THE INVENTION

The present disclosure relates generally to a charging communication system for vehicles, and more particularly, and without limitation, to such a charging communication system with multiple cloud interfaces for communicating charge/discharge instructions to a vehicle.

### BACKGROUND

Vehicles, particularly electric-powered vehicles, communicate with infrastructure such as charging stations to charge a battery within the vehicle or discharge excess charge in a battery to the charging station. When the vehicle is parked at a charging station, the vehicle may communicate with the charging station while interfaced with the charging station or wirelessly through a charge management system run by a vehicle fleet operator. However, instances of poor communications environments or lack of certain types of wireless service may limit efficient communication of vehicle charging states to vehicle and the charging station, which may be housed in a vehicle depot lot.

### SUMMARY OF THE INVENTION

The present disclosure provides for a vehicle-to-point charging communication system with more than one communication interface to charge management systems.

In an aspect of the disclosure, a vehicle-to-everything (V2X) charging communication system is disclosed. The V2X charging communication system may include a vehicle having a rechargeable battery coupled to the vehicle and a vehicle radio frequency (RF) transceiver. The V2X charging communication system may include a first cloud interface in communication with a charging station, where the charging station is configured to charge the rechargeable battery of the vehicle and/or receive charge from the rechargeable battery of the vehicle (common terms that are used include, for example, vehicle-to-ground (V2G), V2X, vehicle-to-infrastructure (V2I)); and a second vehicle interface which can be connected to multiple wireless communication mechanisms such as Bluetooth, WiFi, LoRaWAN or cellular via additional vehicle RF transceivers or manually controlled where the first cloud interface and the second cloud interface are configured to transmit charge/recharge instructions from one or more charge management systems remote from the vehicle.

In one aspect of the disclosure, a Vehicle-to-Everything (V2X) charging communication system is provided. The system includes a software program running on a computer that gives access to charging and discharging functions to a person responsible for controlling the charging and discharging functions and timing on at least one vehicle. The system includes a vehicle of the at least one vehicle. The vehicle includes a rechargeable battery coupled to the vehicle; a charge controller; a controller area network (CAN) communication network connected to the charge controller; and a first radio frequency (RF) transceiver connected to the CAN communication network. The first RF transceiver is configured to receive and transmit data via cellular data and a first cloud interface to control discharging and recharging of the rechargeable battery, and the vehicle further includes at least one additional vehicle radio frequency (RF) transceiver configured to receive and transmit data to control the discharging and recharging of the rechargeable battery.

In some embodiments of this aspect, the person is a fleet operator, the at least one vehicle is a fleet of vehicles and the at least one additional vehicle RF transceiver is configured to provide a second RF service that covers a physical area of the fleet to allow the fleet operator to communicate with each said vehicle in the fleet, even if cellular and cloud connections are unavailable via the fleet operator's interactions with the software program configured to allow the fleet operator to control the discharging and recharging of the rechargeable batteries in the fleet. In some embodiments of this aspect, the at least one additional vehicle RF transceiver is configured to provide the second RF service as one or more of Bluetooth, WiFi, and LoRaWAN. In some embodiments of this aspect, the at least one additional vehicle RF transceiver that is manually controllable to connect to one of multiple wireless communication mechanisms to control the discharging and recharging of the rechargeable battery. In some embodiments of this aspect, the person is a fleet operator, the at least one vehicle is a fleet of vehicles and the at least one additional vehicle RF transceiver is configured to provide the fleet operator with a second means of communicating with the fleet of vehicles if a web page-to-cloud-to-cellular link is non-functional or unavailable.

In some embodiments of this aspect, the at least one additional vehicle RF transceiver receives and transmits data via WiFi to control the discharging and the recharging of the rechargeable battery. In some embodiments of this aspect, the at least one additional vehicle RF transceiver receives and transmits data via Bluetooth to control the discharging and the recharging of the rechargeable battery. In some embodiments of this aspect, the at least one additional vehicle RF transceiver receives and transmits data via LoRaWAN to control the discharging and the recharging of the rechargeable battery. In some embodiments of this aspect, the at least one additional vehicle RF transceiver receives and transmits data via a mobile device to control the discharging and the recharging of the rechargeable battery.

In some embodiments of this aspect, the first RF transceiver is configured to communicate with the first cloud interface via a first communication path corresponding to a cellular network and the at least one additional vehicle RF transceiver is configured to communicate with a second interface via one or more secondary communication paths to control the discharging and recharging of the rechargeable battery. In some embodiments of this aspect, the second interface is associated with the fleet operator, the at least one vehicle is a fleet of vehicles and the one or more secondary communication paths used to control the discharging and recharging of the rechargeable battery provides a secondary RF connection from the fleet operator to each vehicle in the fleet that is a local RF network which is independent of both cellular and cloud connections.

In another aspect of the present disclosure, a method of controlling charging and discharging of a rechargeable battery comprised in a vehicle is provided. The method includes providing a software program running on a computer that gives access to charging and discharging functions to a person responsible for controlling the charging and discharging functions and timing for the vehicle; using a first vehicle radio frequency (RF) transceiver to receive and transmit data to control the charging and discharging functions for the rechargeable battery via cellular data; and using a second vehicle interface to receive and transmit data to control the charging and discharging functions for the rechargeable battery via at least one of: a WiFi transceiver; a Bluetooth transceiver; a LoRaWAN transceiver; and a mobile device.

In some embodiments of this aspect, the person is a fleet operator, the vehicle is part of a fleet of vehicles and the at least one of the WiFi transceiver, the Bluetooth transceiver, the LoRaWAN transceiver and the mobile device is configured to provide a second RF service that covers a physical area of the fleet to allow the fleet operator to communicate with each said vehicle in the fleet, even if cellular and cloud connections are unavailable via the fleet operator's interactions with the software program configured to allow the fleet operator to control the discharging and recharging of the rechargeable batteries in the fleet. In some embodiments of this aspect, the second vehicle interface is configured to receive and transmit data to control the charging and discharging functions for the rechargeable battery via the WiFi transceiver. In some embodiments of this aspect, the second vehicle interface is configured to receive and transmit data to control the charging and discharging functions for the rechargeable battery via the Bluetooth transceiver.

In some embodiments of this aspect, the second vehicle interface is configured to receive and transmit data to control the charging and discharging functions for the rechargeable battery via the LoRaWAN transceiver. In some embodiments of this aspect, the person is a fleet operator, the at least one vehicle is a fleet of vehicles and the at least one additional vehicle RF transceiver is configured to provide the fleet operator with a second means of communicating with the fleet of vehicles if a web page-to-cloud-to-cellular link is non-functional or unavailable.

In yet another aspect of the disclosure, a vehicle is provided. The vehicle includes a rechargeable battery; a charge controller; a controller area network (CAN) communication network connected to the charge controller; and a first radio frequency (RF) transceiver connected to the CAN communication network. The first RF transceiver is configured to receive and transmit data via cellular data and a first cloud interface to control discharging and recharging of the rechargeable battery, and the vehicle further comprises at least one additional vehicle radio frequency (RF) transceiver configured to receive and transmit data to control the discharging and recharging of the rechargeable battery.

In some embodiments of this aspect, the at least one additional vehicle RF transceiver receives and transmits data via at least one of LoRaWAN, WiFi and Bluetooth to control the discharging and recharging of the rechargeable battery. In some embodiments of this aspect, the vehicle is part of a fleet of vehicles and the at least one additional vehicle RF transceiver is configured to provide a second RF service that covers a physical area of the fleet to allow a fleet operator to communicate with each said vehicle in the fleet, even if cellular and cloud connections are unavailable via the fleet operator's interactions with a website configured to allow the fleet operator to control the discharging and recharging of the rechargeable batteries in the fleet.

### BRIEF DESCRIPTION OF THE DRAWINGS

The foregoing and other features of the present disclosure will become more fully apparent from the following description and appended claims, taken in conjunction with the accompanying drawings. These drawings depict only several embodiments in accordance with the disclosure and are, therefore, not to be considered limiting of its scope.

FIG. 1 illustrates an example schematic view of a V2X charging communication system, according to aspects of the disclosure.

FIG. 2 is a block diagram a charging communication system, according to another aspect of the disclosure.

FIG. 3 is a flowchart of a method of providing a charging communication system according to yet another aspect of the disclosure.

In the following detailed description, various embodiments are described with reference to the appended drawings. The skilled person will understand that the accompanying drawings are schematic and simplified for clarity. Like reference numerals refer to like elements or components throughout. Like elements or components will therefore not necessarily be described in detail with respect to each figure.

### DETAILED DESCRIPTION

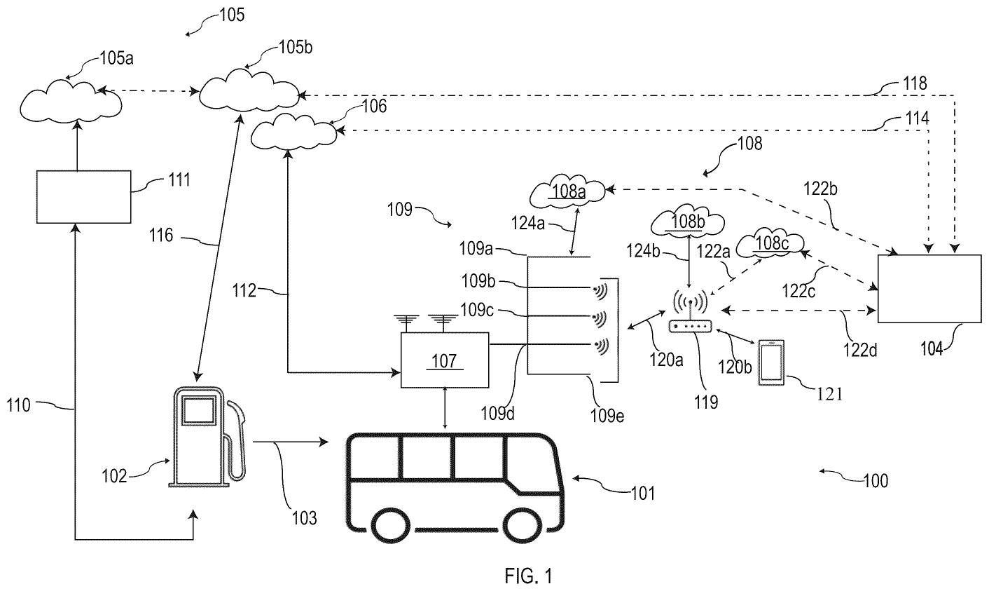

Electric vehicles operated by fleets, such as school buses or trucks from time to time may need to charge their electric batteries when low or conversely discharge the electric batteries when excess charge is selectively available for building or grid support. These fleet vehicles may travel to a depot, service station or service station/lot, to accomplish the charge/discharge function. Fleet infrastructure has been developed with charging stations located at various places, where the charging stations are in communication with fleet charge management systems operated over an extended communications network. An example of a charging station in communication with a fleet charge management system over a network according to one embodiment of the disclosure is shown in FIG. 1.

Referring to FIG. 1, a V2X charging communication system 100 is illustrated. The V2X charging communication system 100 includes a bi-directional electric vehicle (EV) 101, such as an electric powered car, bus, truck, or other vehicle that requires charging and discharging through a bi-directional charging station 102. As known in the art, the term “bi-directional” refers to the capability of a device to both receive and provide charge. In an aspect, the charging station 102 may be located in a vehicle depot, maintenance/service facility or parking lot for vehicles to use when not in transit. The EV 101 may interface with the charging station 102 via charging infrastructure connection 103, such as a charging cable or other charging mechanism, including wireless inductive charging, for example. In an aspect of the disclosure, a fleet operator 104 may operate a fleet of EVs 101 and may need to control the charging and discharging of the fleet of EVs 101 remotely. In some embodiments, the phrase “fleet operator” may be used to refer to a computer with a software program running thereon and that is used by the fleet operator for controlling charging/discharging functions and the timing of such functions to charge/discharge the EVs 101 in its fleet. In some embodiments, the software program may be a website configured to allow the fleet operator to control the discharging and recharging of the rechargeable batteries in the fleet. In other embodiments, the software program may be another known type of software application configured to allow the fleet operator to provide user inputs to control the discharging and recharging of the rechargeable batteries in the fleet.

The V2X charging communication system 100 may include one or more charger cloud interfaces 105 (105a—e.g., a grid supplier/grid integrator, 105b—e.g., EVSE (electric vehicle supply equipment) DC charger control), such as an original equipment manufacturer (OEM) cloud or grid integrator. The charger cloud interface 105 provides a cloud interface for the charging station 102. Other cloud interfaces are provided in the system 100, which are described in more detail below.

In the present disclosure, the term “interface” (e.g., cloud interface, vehicle interface, etc.) generally refers to a communication interface for setting up and maintaining a wireless and/or wired connection between components of the system. The communication interface may be formed as or may include, for example, one or more RF transceivers for wireless connection. The interface may be formed as or may include, for example, network interface cards or other circuitry for wired connection, such as an Ethernet cable connection. Thus, the phrase “cloud interface” may generally refer to a communication interface in the cloud and the phrase “vehicle interface” may generally refer to an on-board communication interface in the vehicle.

In the diagram in FIG. 1, the cloud symbols imply a transceiver operating in the cellular RF spectrum such as 3G/4G or the like, which is connected to the Internet.

Having generally described the cloud interface in the V2X context, which is known by those of ordinary skill in the art, a description of the present disclosure continues.

The V2X charging communication system 100 may have additional cloud interfaces including a first cloud interface 106, which may be provided by a vehicle supplier for the EV 101. The V2X communication system 100 may further include an on-board modem 107, a second cloud interface 108 and one or more communication paths 109 connecting the modem 107 to the second cloud interface 108. The system 100 includes:
connection 110 between charging station 102 and power grid supplier 111 for energy flow;
primary cellular communication 112 for the EV 101;
Internet connection 114 between fleet operator 104 and first cloud interface 106;
primary cellular connection 116 between charging station 102 and charger cloud interface 105b; and
Internet connection 118 between fleet operator 104 and charger cloud interface 105b, as in FIG. 1.

The fleet operator 104 may communicate with the charger cloud interfaces 105a, 105b via a signal transmitted over the Internet (via 118). The fleet operator 104 may also communicate with the first cloud interface 106 via a signal transmitted over the Internet (via 114).

From the charger cloud interface 105a, 105b, the OEM cloud or grid integrator may request a charge or discharge function for the EV 101 through a cellular signal to a corresponding modem 107 located on the EV 101. For example, the request may be transmitted from cloud interface 105 along the Internet connection 118 to fleet operator 104, along Internet connection 114 to cloud interface 106 and then across the primary cellular connection 112 to the modem 107 inside the EV 101. In an aspect of the disclosure, the modem 107 may have at least one controller area network (CAN) port for communication with on-vehicle networks and at least one cloud interface.

Use of the charger cloud interface 105 to the charging station 102 via e.g., 116 and 118 may be through a conventional charging management system that charging companies typically implement through software applications run on a computer by the fleet operator/manager 104. Fleet operators 104 can coordinate the charging schedules/timing of vehicles such as EV 101, where the charging station 102 initiates the process with the EV 101.

In an aspect, a grid operator operating through the charger cloud interface 105a, 105b may request a charge or discharge function for the EV 101 by communicating with the charging station 102 through a cellular signal, such as via 116.

In both cases involving the charger cloud interface 105a, 105b, the charge/discharge function is initiated at the charging station 102 side, rather than initiated by the EV 102. Charging station 102 may initiate charging/discharging process via the charging infrastructure connection 103, which may provide a communication path to the EV 101 in addition to power/energy flow.

In an aspect of the disclosure, V2X charging communication system 100 may include a second cloud interface 108, different from the first cloud interface 106. Through the second cloud interface 108, a party, such as a fleet operator 104, may communicate with the EV 101 to an on-vehicle CAN port via one or more secondary communication paths 109. FIG. 1 shows multiple cloud interfaces 108a, 108b and 108c. In an aspect of the disclosure, the one or more secondary communication paths 109 may include cellular 109a, WiFi® 109b or other wireless local area network (WLAN), Bluetooth® 109c or other wireless personal area network (WPAN), LoRaWAN® 109d or other low-power long-range wide area network (LPWAN), manual control 109e mounted on the EV 101 or other communication pathways known to one of skill in the art.

In an aspect of the disclosure, the first cloud interface 106 and/or the second cloud interface 108 may be cloud services such as those provided by conventional cloud servers, Internet-of-Things (IoT) networks, local area networks, remote charge management networks/services or grid operator networks/services. In an aspect, the cloud services may be located or provided remotely from the EV 101. Other implementations of the first cloud interface 106 and/or the second cloud interface 108 may be possible as known to one of skill in the art to implement the V2X charging communication system 100.

In some embodiments, the on-board modem 107 may be a dual-band modem, as illustrated in FIG. 1. This may allow the EV 101 to communicate in more than one frequency band, such as, for example, a primary band—cellular network frequency band (e.g., LTE/5G bands)—and an alternative band—WiFi, Bluetooth, or sub-GHz band (e.g., LoRaWAN frequency band). The alternative band may allow charge management systems to transmit charge/recharge instructions to the EV 101, even in poor communication environments.

FIG. 1 shows an IoT gateway 119 (IoT gateway can be connected to the fleet operator in multiple ways including cellular cloud (108b), Internet cloud (108c) or direct computer connection (122d) (Ethernet or other common hardwire communication protocol). IoT gateway 119 may facilitate wireless connection via the one or more secondary communication paths of the WiFi 109b, Bluetooth 109c, LoRaWAN 109d and manual control 109e and may allow a remote fleet operator 104 to communicate with the EV 101, according to an aspect of the present disclosure.

Alternative communication paths 120a, 120b may be provided by the present disclosure. Communication path 120a may include one or more alternative communication links between the EV's 101 modem 107 (e.g., alternative band RF transceiver) and the IoT gateway 119. Communication path 120a may include one or more of WiFi®, Bluetooth® and LoRaWAN®. Communication path 120b may be a communication link between the IoT gateway 119 and fleet operator's mobile device 121.

Secondary Internet communication paths 122a, 122b, 122c between the fleet operator 104 and second cloud interfaces 108a, 108c may allow the fleet operator 104 to access cloud services according to an aspect of the disclosure. Specifically, the Ethernet or hardwire “cable” communication path 122d allows the fleet operator to control V2X charging with vehicles located within the communication range of methods described for 109b, 109c, 109d independent of cloud-based connectivity. Secondary wired Internet communication path 122d (e.g., Ethernet) between the fleet operator 104 and IoT gateway 119 may also be provided according to an aspect of the disclosure. By providing such secondary communication paths according to the disclosure, connectivity between the vehicle/EV 101 and remote fleet operator 104 can be maintained, even in instances of poor communications environments or lack of certain types of wireless service, such as, when the EV 101 is housed in a vehicle depot lot or parking lot where fleet vehicles are stored when not in transit. This may be considered the physical area of the fleet where a second RF service covering such physical area allows the fleet operator to communicate with the vehicles in the fleet, even if cellular and cloud connections are unavailable.

FIG. 1 also shows cellular network communication paths 124a, 124b which may allow the EV's 101 modem 107 (via e.g., primary band RF transceiver) to access cellular connected cloud services to control discharging and recharging of the rechargeable battery.

In an aspect of the disclosure, the second cloud interface 108 may be supported by application programming interfaces (APIs) that may be customized to suit a party seeking to use the V2X charging communication system 100. This API flexibility may allow parties who do not wish to or are unable to use a charge management system enabled by cloud interface 106 or 105 to communicate charging decisions to the EV 101 or the charging station 102.

In an aspect of the disclosure, the EV 101 may include an internal network communication bus, such as a controller area network (CAN) bus. For purposes of this disclosure and without limitation, a controller area network (CAN) is a vehicle bus standard designed to enable efficient communication primarily between electronic control units (ECUs). Originally developed to reduce the complexity and cost of electrical wiring in automobiles through multiplexing, the CAN bus protocol has since been adopted in various other contexts. This broadcast-based, message-oriented protocol ensures data integrity and prioritization through a process called arbitration, allowing the highest priority device to continue transmitting if multiple devices attempt to send data simultaneously, while others back off. Its reliability is enhanced by differential signaling, which mitigates electrical noise. Common versions of the CAN protocol include CAN 2.0, CAN FD, and CAN XL which vary in their data rate capabilities and maximum data payload sizes.

In an aspect of the disclosure, the EV 101 may communicate with the external network(s) via a cellular modem or other suitable wireless modem using signals transmitted by the cellular/wireless modem, such as modem 107.

The disclosed V2X charging communication system 100 may be used to extend the capabilities of the existing “vehicle to grid” (V2G) systems with a “vehicle-to-‘anything’” system, including the contemplated cloud interfaces implemented through APIs for charge management services located anywhere.

The CAN port on the modem 107 for communicating with the second cloud interface 108 allows flexibility in establishing additional methods to control and manage charging events using a variety of wireless communication methods (examples include but not limited to cellular bands: 3G, 4G, 5G, WiFi®, Bluetooth®, LoRaWAN®, NB-IoT, LTE-M) or manual control connected directly to the second vehicle communication channel 110. This flexibility allows for better reliability due to the redundant communication options. This also provides increased flexibility to create unique charging control infrastructures at customer locations where the typical primary cellular communication options are not adequate.

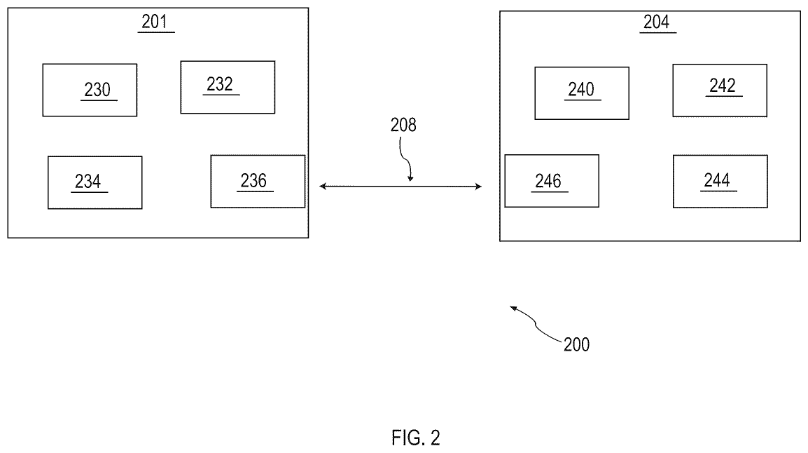

FIG. 2 is a block diagram of example hardware components used in a charging communication system 200 according to an aspect of the disclosure. Like reference numerals for the systems 100 and 200 refer to like elements or components throughout, except with ‘1’ in the hundreds place replaced with ‘2’. Thus, like elements or components will not necessarily be described in detail with respect to FIG. 2.

The charging communication system 200 includes a vehicle 201 and a computer 204 connected via a second cloud interface 208, according to an aspect of the disclosure. Vehicle 201 includes a rechargeable battery 230, charge controller 232, CAN communication network 234 and two or more RF transceivers 236.

The computer 204 may be a fleet operator's computer, which may be a general-purpose or special-purpose computer, and includes a processor 240, memory 242, storage 244 and one or more input/output (I/O) device 246. Processor 240 communicates with memory 242 and storage 244. Memory 242 stores computer instructions that, when executed by processor 240, cause the computer to perform operations as described herein. Storage 244 may store software, databases or other data structures used during execution. I/O devices 246 can include user interfaces, network interfaces (e.g., wireless/RF transceivers and/or hardwired/Ethernet connections to IoT gateway), and the like. While a single processor and memory are shown for simplicity, the computer may include distributed or cloud-based computing environments.

These computer hardware components may be used to perform the methods and features described herein, such as receiving and transmitting data over an alternative (e.g., non-cellular) network to control discharging and recharging of the rechargeable battery 230.

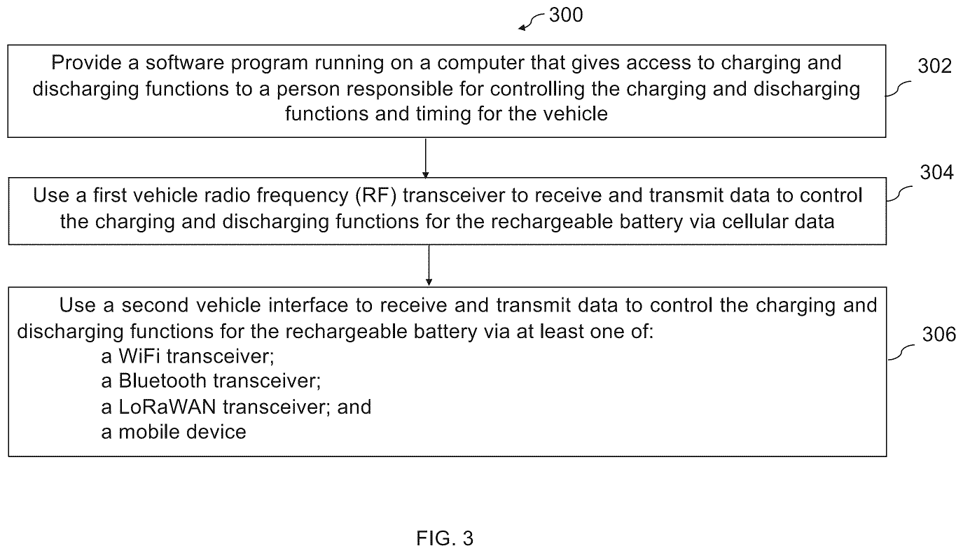

FIG. 3 is a flowchart illustrating an example method 300 executed by the fleet operator computer 104, 204, EV 101, 201 or other computing components in the system 100, 200 according to some embodiments of the present disclosure. At step 302, there is provided a software program running on a computer, such as computer 104, 204, that gives access to charging and discharging functions to a person responsible for controlling the charging and the discharging functions and timing for a vehicle. Step 304 includes using a first vehicle radio frequency (RF) transceiver, such as a first RF transceiver 236, to receive and transmit data to control the charging and discharging functions for the rechargeable battery 230 via cellular data. As one non-limiting example, first vehicle RF transceiver 236 may be tuned and configured to operate in the cellular frequency band and may be configured to wirelessly receive charge/discharge requests from (and wirelessly transmit charge/discharge responses to) the fleet operator's computer 104, 204 over the cellular network. Step 306 includes using a second vehicle interface, such as a second RF transceiver 236, to receive and transmit data to control the charging and discharging functions for the rechargeable battery via at least one of: a WiFi transceiver; a Bluetooth transceiver; a LoRaWAN transceiver; and a mobile device 121. As one non-limiting example, a second RF transceiver 236 may be tuned and configured to operate in a non-cellular frequency band (e.g., WiFi, LoRaWAN, Bluetooth or other local RF network services) and may be configured to wirelessly receive charge/discharge requests from (and wirelessly transmit charge/discharge responses to) the fleet operator's computer 104, 204 over the local non-cellular network.

As used herein, the term “CAN communication network” is intended to broadly encompass not only CAN bus systems but also other types of in-vehicle communication networks that facilitate data exchange between electronic control units (ECUs), sensors, and other vehicle components.

The term “RF transceiver,” as used herein, is intended to be interpreted broadly to include any wireless, radio frequency (RF) communication component, including transmitters, receivers, and transmitter-receiver combinations (i.e., transceivers). The term encompasses devices capable of only transmission, only reception, or both transmission and reception of RF signals. Therefore, the use of the term “RF transceiver” should not be limited to devices that perform both transmitting and receiving functions, unless explicitly stated otherwise.

With respect to the use of plural and/or singular terms herein, those having skill in the art can translate from the plural to the singular and/or from the singular to the plural as is appropriate to the context and/or application. The various singular/plural permutations may be expressly set forth herein for sake of clarity. Unless otherwise noted, the use of the words “approximate,” “about,”“around,”“substantially,”etc., mean plus or minus ten percent.

Numerous modifications to the present invention will be apparent to those skilled in the art in view of the foregoing description. It is not desired to limit the invention to the exact construction and operation shown and described, and accordingly, all suitable modifications and equivalents may be resorted to, falling within the scope of the invention. Accordingly, this description is to be construed as illustrative only of the principles of the invention and is presented for the purpose of enabling those skilled in the art to make and use the invention and to teach the best mode of carrying out the same. The exclusive rights to all modifications which come within the scope of the appended claims are reserved. All patents, patent publications and applications, and other references cited herein are incorporated by reference herein in their entirety.

I/We claim:

1. A Vehicle-to-Everything (V2X) charging communication system comprising:
a software program running on a computer that gives access to charging and discharging functions to a person responsible for controlling the charging and discharging functions and timing on at least one vehicle; and
a vehicle of the at least one vehicle comprising:
a rechargeable battery coupled to the vehicle;
a charge controller;
a controller area network (CAN) communication network connected to the charge controller; and
a first radio frequency (RF) transceiver connected to the CAN communication network,
wherein the first RF transceiver is configured to receive and transmit data via cellular data and a first cloud interface to control discharging and recharging of the rechargeable battery, and
wherein the vehicle further comprises at least one additional vehicle radio frequency (RF) transceiver configured to receive and transmit data to control the discharging and recharging of the rechargeable battery.

2. The system of claim 1, wherein the person is a fleet operator, the at least one vehicle is a fleet of vehicles and the at least one additional vehicle RF transceiver is configured to provide a second RF service that covers a physical area of the fleet to allow the fleet operator to communicate with each said vehicle in the fleet, even if cellular and cloud connections are unavailable via the fleet operator's interactions with the software program configured to allow the fleet operator to control the discharging and recharging of the rechargeable batteries in the fleet.

3. The system of claim 2, wherein the at least one additional vehicle RF transceiver is configured to provide the second RF service as one or more of Bluetooth, WiFi, and LoRaWAN.

4. The system of claim 1, wherein the at least one additional vehicle RF transceiver that is manually controllable to connect to one of multiple wireless communication mechanisms to control the discharging and recharging of the rechargeable battery.

5. The system of claim 1, wherein the person is a fleet operator, the at least one vehicle is a fleet of vehicles and the at least one additional vehicle RF transceiver is configured to provide the fleet operator with a second means of communicating with the fleet of vehicles if a web page-to-cloud-to-cellular link is non-functional or unavailable.

6. The system of claim 1, wherein the at least one additional vehicle RF transceiver receives and transmits data via WiFi to control the discharging and the recharging of the rechargeable battery.

7. The system of claim 1, wherein the at least one additional vehicle RF transceiver receives and transmits data via Bluetooth to control the discharging and the recharging of the rechargeable battery.

8. The system of claim 1, wherein the at least one additional vehicle RF transceiver receives and transmits data via LoRaWAN to control the discharging and the recharging of the rechargeable battery.

9. The system of claim 1, wherein the at least one additional vehicle RF transceiver receives and transmits data via a mobile device to control the discharging and the recharging of the rechargeable battery.

10. The system of claim 1, wherein the first RF transceiver is configured to communicate with the first cloud interface via a first communication path corresponding to a cellular network and the at least one additional vehicle RF transceiver is configured to communicate with a second interface via one or more secondary communication paths to control the discharging and recharging of the rechargeable battery.

11. The system of claim 10, wherein the second interface is associated with the fleet operator, the at least one vehicle is a fleet of vehicles and the one or more secondary communication paths used to control the discharging and recharging of the rechargeable battery provides a secondary RF connection from the fleet operator to each vehicle in the fleet that is a local RF network which is independent of both cellular and cloud connections.

12. A method of controlling charging and discharging of a rechargeable battery comprised in a vehicle, the method comprising:
providing a software program running on a computer that gives access to charging and discharging functions to a person responsible for controlling the charging and discharging functions and timing for the vehicle;
using a first vehicle radio frequency (RF) transceiver to receive and transmit data to control the charging and discharging functions for the rechargeable battery via cellular data; and
using a second vehicle interface to receive and transmit data to control the charging and discharging functions for the rechargeable battery via at least one of:
a WiFi transceiver;
a Bluetooth transceiver;
a LoRaWAN transceiver; and
a mobile device.

13. The method of claim 12, wherein the person is a fleet operator, the vehicle is part of a fleet of vehicles and the at least one of the WiFi transceiver, the Bluetooth transceiver, the LoRaWAN transceiver and the mobile device is configured to provide a second RF service that covers a physical area of the fleet to allow the fleet operator to communicate with each said vehicle in the fleet, even if cellular and cloud connections are unavailable via the fleet operator's interactions with the software program configured to allow the fleet operator to control the discharging and recharging of the rechargeable batteries in the fleet.

14. The method of claim 12, wherein the second vehicle interface is configured to receive and transmit data to control the charging and discharging functions for the rechargeable battery via the WiFi transceiver.

15. The method of claim 12, wherein the second vehicle interface is configured to receive and transmit data to control the charging and discharging functions for the rechargeable battery via the Bluetooth transceiver.

16. The method of claim 12, wherein the second vehicle interface is configured to receive and transmit data to control the charging and discharging functions for the rechargeable battery via the LoRaWAN transceiver.

17. The method of claim 12, wherein the person is a fleet operator, the at least one vehicle is a fleet of vehicles and the at least one additional vehicle RF transceiver is configured to provide the fleet operator with a second means of communicating with the fleet of vehicles if a web page-to-cloud-to-cellular link is non-functional or unavailable.

18. A vehicle comprising:
a rechargeable battery;
a charge controller;
a controller area network (CAN) communication network connected to the charge controller; and
a first radio frequency (RF) transceiver connected to the CAN communication network, and
wherein the first RF transceiver is configured to receive and transmit data via cellular data and a first cloud interface to control discharging and recharging of the rechargeable battery, and
wherein the vehicle further comprises at least one additional vehicle radio frequency (RF) transceiver configured to receive and transmit data to control the discharging and recharging of the rechargeable battery.

19. The vehicle of claim 18, wherein the at least one additional vehicle RF transceiver receives and transmits data via at least one of LoRaWAN, WiFi and Bluetooth to control the discharging and recharging of the rechargeable battery.

20. The vehicle of claim 18, wherein the vehicle is part of a fleet of vehicles and the at least one additional vehicle RF transceiver is configured to provide a second RF service that covers a physical area of the fleet to allow a fleet operator to communicate with each said vehicle in the fleet, even if cellular and cloud connections are unavailable via the fleet operator's interactions with a website configured to allow the fleet operator to control the discharging and recharging of the rechargeable batteries in the fleet.
